(19) United States
(12) Patent Application Publication
(10) Pub. No.: US 2020/0010057 A1
(43) Pub. Date: Jan. 9, 2020

(54) DRUM BRAKE

(71) Applicant: MANDO CORPORATION, Gyeonggi-do (KR)

(72) Inventor: Joon Geun CHO, Gyeonggi-do (KR)

(21) Appl. No.: 16/446,592

(22) Filed: Jun. 19, 2019

(30) Foreign Application Priority Data
Jul. 5, 2018 (KR) 10-2018-0078347
Jul. 19, 2018 (KR) 10-2018-0084118

(51) Int. Cl. B60T 1/06; F16D 51/24

(52) U.S. Cl. CPC B60T 1/067; F16D 2121/04; F16D 51/24

(57) ABSTRACT

A drum brake according to an embodiment of the present disclosures, which is a drum brake including a drum configured to rotate together with wheels, and a first brake shoe and a second brake shoe to which linings that rub against an inner circumferential surface of the drum are attached, includes: a first pivot fixing part configured to fix one end of the first brake shoe in a pivoting manner so that the first brake shoe outwardly operates and thus the lining of the first brake shoe rubs against the inner circumferential surface of the drum when the first brake shoe pivots in one direction with respect to the one end of the first brake shoe; and a second pivot fixing part configured to fix one end of the second brake shoe in the pivoting manner so that the second brake shoe operates outwardly and thus the lining of the second brake shoe rubs against the inner circumferential surface of the drum when the second brake shoe pivots in the other direction with respect to the one end of the second brake shoe.

### CROSS-REFERENCE TO RELATED APPLICATION

This application claims priority to and the benefit of Korean Patent Application No. 10-2018-0078347, filed on Jul. 5, 2018, Korean Patent Application No. 10-2018-0084118, filed on Jul. 19, 2018, the disclosure of which is incorporated herein by reference in its entirety.

### BACKGROUND

### 1. Field of the Invention

The present disclosure relates to a drum brake, and more specifically, to a drum brake configured to provide improved braking performance

### 2. Discussion of Related Art

Generally, a drum brake configured to generate a braking force by rubbing against a drum rotating together with wheels uses a hydraulic pressure, or a parking cable linked with a parking brake operating lever to generate a braking force by rubbing a brake shoe to which a lining is attached against a drum.

A conventional drum brake configured to perform these functions includes a drum provided in a cylindrical shape and configured to rotate together with wheels, a pair of brake shoes disposed on a back plate to face an inner circumferential surface of the drum and having linings attached to outer circumferences thereof, and a wheel cylinder having a piston embedded therein to receive a braking hydraulic pressure and operate the brake shoes outwardly in a radial direction.

In the pair of brake shoes, the linings attached to the outer circumferences of the brake shoes come into contact with the inner circumferential surface of the drum to generate a frictional braking force, and a first brake shoe may be provided on a forward rotation direction side of the drum with respect to the wheel cylinder, and a second brake shoe may be provided on the opposite side.

In the conventional drum brake, each of the first brake shoe and the second brake shoe is disposed so that one end is supported by an anchor part and the other end comes into contact with the wheel cylinder. Further, the anchor part and the brake shoes are in surface contact with each other to move along an inclined anchor part during an operation of each brake shoe. Accordingly, since one end of each of the brake shoes is not fixedly supported by the anchor part, there is a problem that braking efficiency is low due to slippage or the like.

### Patent Document

Korean Application Patent No. 10-0435197 “Drum brake,” applied in Jun. 9, 2004

### SUMMARY OF THE INVENTION

The present disclosure is directed to providing a drum brake including a first brake shoe and a second brake shoe to which linings that rub against an inner circumferential surface of a drum are attached, wherein each of the first brake shoe and the second brake shoe has one end pivotally fixed to be operated outwardly during pivot rotation and thus friction between an inner circumferential surface of the drum and the linings of the brake shoes is stably and efficiently performed.

According to an aspect of the present disclosure, there is provided a drum brake including a drum configured to rotate together with wheels, and a first brake shoe and a second brake shoe to which linings that rub against an inner circumferential surface of the drum are attached, the drum brake including: a first pivot fixing part configured to fix one end of the first brake shoe in a pivoting manner so that the first brake shoe operates outwardly and thus the lining of the first brake shoe rubs against the inner circumferential surface of the drum when the first brake shoe pivots in one direction with respect to the one end of the first brake shoe; and a second pivot fixing part configured to fix one end of the second brake shoe in a pivoting manner so that the second brake shoe operates outwardly and thus the lining of the second brake shoe rubs against the inner circumferential surface of the drum when the second brake shoe pivots in the other direction with respect to the one end of the second brake shoe.

In this case, the first pivot fixing part and the second pivot fixing part may each include a fixing pin fixed to an anchor block through the one end of the first brake shoe and the one end of the second brake shoe, respectively.

Further, each of the first brake shoe and the second brake shoe may include a rim having an outer circumferential surface to which the lining is attached, and a plate-shaped web coupled to an inner circumference of the rim, and the first pivot fixing part and the second pivot fixing part may be fixed to the anchor block through the web of the first brake shoe and the web of the second brake shoe, respectively.

In addition, the one end of the first brake shoe and the one end of the second brake shoe may be disposed adjacent to each other, and the first pivot fixing part and the second pivot fixing part may be symmetrically disposed.

In addition, the other end of the first brake shoe and the other end of the second brake shoe may be disposed to come into contact with a wheel cylinder configured to receive a braking hydraulic pressure to operate the first brake shoe and the second brake shoe outwardly.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a perspective view of a drum brake according to an embodiment of the present disclosure;

FIG. 2 is a perspective view of one end portions of a first brake shoe and a second brake shoe of the drum brake according to the embodiment of the present disclosure viewed from the inside of the drum brake;

FIG. 3 is a perspective view of one end portions of the first brake shoe and the second brake shoe of the drum brake according to the embodiment of the present disclosure viewed from the outside of the drum brake; and

FIG. 4 is a view illustrating the drum brake in which one end portions of the first brake shoe and the second brake shoe are fixed in a manner not according to the present disclosure.

### DETAILED DESCRIPTION OF EXEMPLARY EMBODIMENTS

Hereinafter, exemplary embodiments of the present disclosure will be described in detail with reference to the accompanying drawings which may allow one of ordinary skill in the art to easily perform the present disclosure. The present disclosure may be implemented in various forms and is not limited to the following embodiments. Components not related to the description are not included in the drawings to clearly describe the present disclosure, and the same reference symbols are used for the same or similar components in the description.

It should be further understood that the terms “include,” “including,” “provide,” “providing,” “have,” and/or “having” specify the presence of stated features, integers, steps, operations, elements, components, and/or groups thereof but do not preclude the presence or addition of one or more other features, integers, steps, operations, elements, components, and/or groups thereof.

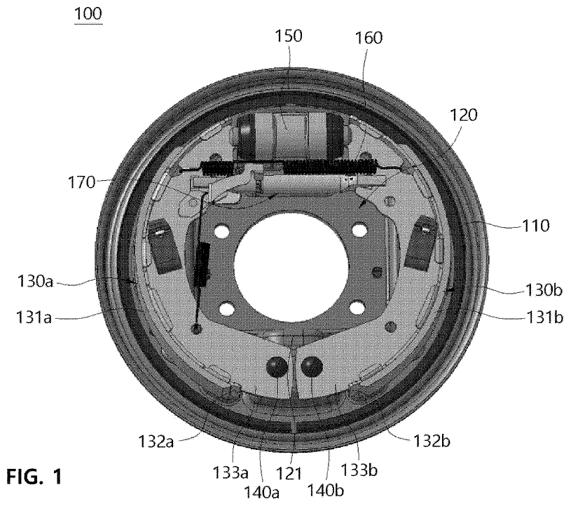

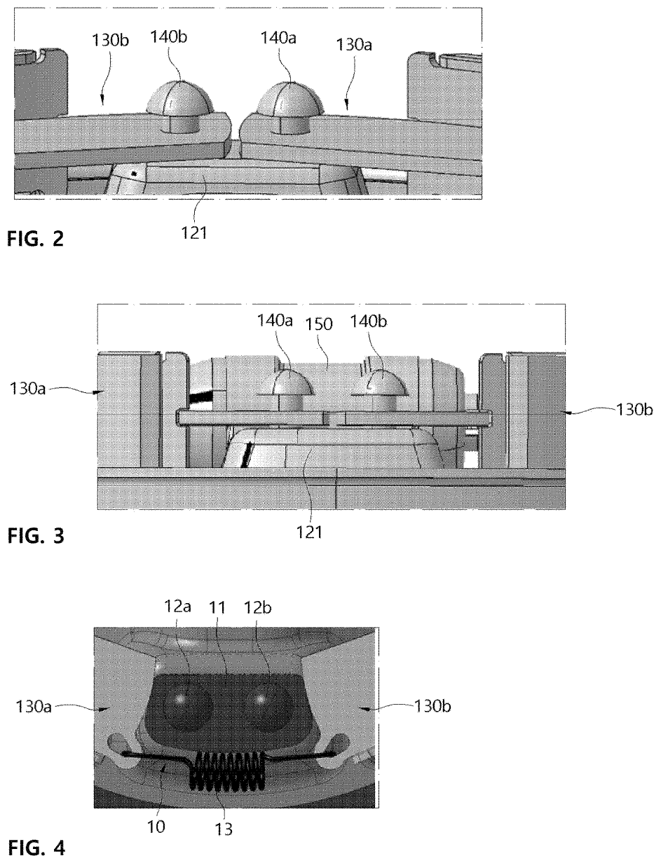

A perspective view of a drum brake according to an embodiment of the present disclosure is shown in FIG. 1, a perspective view of one end portions of a first brake shoe and a second brake shoe of the drum brake according to the embodiment of the present disclosure viewed from the inside of the drum brake is shown in FIG. 2, and a perspective view of one end portions of the first brake shoe and the second brake shoe of the drum brake according to the embodiment of the present disclosure viewed from the outside of the drum brake is shown in FIG. 3.

Referring to FIGS. 1 to 3, a drum brake 100 according to the embodiment of the present disclosure includes a drum 110, a back plate 120, a first brake shoe 130a, a second brake shoe 130b, a first pivot fixing part 140a, a second pivot fixing part 140b, a wheel cylinder 150, a return spring 160, and an adjuster 170.

The drum 110 is a cylindrical-shaped member configured to rotate together with wheels of a vehicle. In the drum 110, an inner circumferential surface thereof rubs with a lining 131a of the first brake shoe 130a and a lining 131b of the second brake shoe 130b, and accordingly, a braking force is generated.

The back plate 120 is a member to which configurations of the drum brake 100 except the drum 110 are fixed. The back plate 120 is relatively fixed with respect to the drum 110. The back plate 120 includes an anchor block 121 to which one end of the first brake shoe 130a and one end of the second brake shoe 130b are fixed to a lower end thereof. More specifically, the anchor block 121 may be provided in a shape configured to protrude frontward from a center portion of a lower end of a front surface of the back plate 120.

The first brake shoe 130a and the second brake shoe 130b are disposed on the back plate 120 to face the inner circumferential surface of the drum 110, and the linings 131a and 131b are attached to an outer circumferential surface. Each of the first brake shoe 130a and the second brake shoe 130b is formed in an arc shape and a cross-section cut in a radial direction has a ‘T’ shape. The first brake shoe 130a and the second brake shoe 130b include rims 132a and 132b each formed in an arc shape so that the linings 131a and 131b are attached to outer circumferential surfaces thereof, and plate-shaped webs 133a and 133b configured to extend from inner circumferential surfaces of the rims 132a and 132b, respectively. The rims 132a and 132b may be coupled to and integrally formed with the webs 133a and 133b through welding or the like, respectively.

In the embodiment of the present disclosure, the first brake shoe 130a may be a leading shoe disposed at a side of a proceeding rotation direction of the drum 110 with respect to the wheel cylinder 150, and the second brake shoe 130b may be a trailing shoe disposed opposite to the first brake shoe 130a. As described above, a drum brake including a pair of brake shoes is referred to as a leading/trailing (L/T) type drum brake.

In this case, functions of the leading shoe and the trailing shoe are variable, and accordingly, when braking is performed while the vehicle proceeds, the first brake shoe 130a may serve as the leading shoe, and the second brake shoe 130b may serve as the trailing shoe, and when the braking is performed while the vehicle is moving backward, the second brake shoe 130b may serve as the leading shoe, and the first brake shoe 130a may serve as the trailing shoe.

The first pivot fixing part 140a fixes one end of the first brake shoe 130a in a pivoting manner so that the first brake shoe 130a operates outwardly and thus the lining 131a of the first brake shoe 130a rubs against the inner circumferential surface of the drum 110 when the first brake shoe 130a pivots in one direction with respect to the one end of the first brake shoe 130a.

Further, the second pivot fixing part 140b fixes one end of the second brake shoe 130b in a pivoting manner so that the second brake shoe 130b operates outwardly and thus the lining 131b of the second brake shoe 130b rubs against the inner circumferential surface of the drum 110 when the second brake shoe 130b pivots in the other direction with respect to the one end of the second brake shoe 130b.

In the embodiment of the present disclosure, the first pivot fixing part 140a and the second pivot fixing part 140b may include a fixing pin fixed to the anchor block 121 through the one end of the first brake shoe 130a and the one end of the second brake shoe 130b, respectively. In this case, the first pivot fixing part 140a and the second pivot fixing part 140b may include head portions on end portions thereof to be engaged with the first brake shoe 130a and the second brake shoe 130b, respectively.

More specifically, the first pivot fixing part 140a and the second pivot fixing part 140b may be fixed to the anchor block 121 through the web 133a of the first brake shoe 130a and the web 133b of the second brake shoe 130b, and for this end, a through hole may be formed in each of the web 133a of the first brake shoe 130a and the web 133b of the second brake shoe 130b.

Further, the one end of the first brake shoe 130a and the one end of the second brake shoe 130b may be disposed adjacent to each other, and the first pivot fixing part 140a and the second pivot fixing part 140b may be symmetrically disposed.

The wheel cylinder 150 receives a braking hydraulic pressure to operate the first brake shoe 130a and the second brake shoe 130b outwardly in a radial direction. A piston configured to operate the first brake shoe 130a and the second brake shoe 130b outwardly is disposed in the wheel cylinder 150. In the embodiment of the present disclosure, the other end of the first brake shoe 130a and the other end of the second brake shoe 130b are disposed to come into contact with the wheel cylinder 150, and when the braking is demanded while the vehicle is driven, the wheel cylinder 150 receives the hydraulic pressure and operates the first brake shoe 130a and the second brake shoe 130b outwardly so that the linings 131a and 131b of the first brake shoe 130a and the second brake shoe 130b rub with the inner circumferential surface of the drum 110 to generate the braking force.

The return spring 160 provides an elastic force which restores the first brake shoe 130a and the second brake shoe 130b to the inside when a braking action is released. That is, when the outward operations of the first brake shoe 130a and the second brake shoe 130b by the wheel cylinder 150 are stopped, the return spring 160 restores the first brake shoe 130a and the second brake shoe 130b to original positions.

The adjuster 170 serves to compensate for intervals between the linings 131a and 131b of the first brake shoe 130a and the second brake shoe 130b and the drum 110. Specifically, when thicknesses of the lining 131a of the first brake shoe 130a and the lining 131b of the second brake shoe 130b are decreased due to repetitive friction between the linings 131a and 131b, the adjuster 170 moves the first brake shoe 130a and the second brake shoe 130b to the outer side by the decreased thicknesses.

In FIG. 4, a comparative example of the drum brake in which one end portions of the first brake shoe 130a and the second brake shoe 130b are fixed in a manner not according to the present disclosure is shown. As shown in FIG. 4, the one end of the first brake shoe 130a and the one end of the second brake shoe 130b are supported by a fixing part 10. The fixing part 10 includes a fixing plate 11 disposed on the anchor block 121 between the one end of the first brake shoe 130a and the one end of the second brake shoe 130b, a pair of fixing pins 12a and 12b configured to fix the fixing plate 11 to the anchor block 121, and a lower return spring 13 configured to connect the one end of the first brake shoe 130a and the one end of the second brake shoe 130b to provide elasticity.

Referring to FIG. 4, the one end of the first brake shoe 130a and the one end of the second brake shoe 130b come into surface contact with the fixing plate 11 of the anchor block 121. In other words, a structure in which the one end of the first brake shoe 130a and the one end of the second brake shoe 130b are fixedly supported in the pivoting manner by the anchor block 121 is not included. Accordingly, probability of an occurrence of slippage may be high when the drum brake is operated, and accordingly, braking efficiency may be degraded.

In comparison with the above, as described above, in the drum brake 100 according to the embodiment of the present disclosure, since the one end of the first brake shoe 130a and the one end of the second brake shoe 130b are fixed in the pivoting manner using the first pivot fixing part 140a and the second pivot fixing part 140b, respectively, slippage may not occur during an operation process, and improved braking performance may be provided through a pivot structure. Further, in comparison with the structure shown in FIG. 4, according to the embodiment of the present disclosure, since a configuration related to fixing the one end of the first brake shoe 130a and the one end of the second brake shoe 130b is simplified, the number of required components may be reduced.

A drum brake according to an embodiment of the present disclosure can prevent slippage of a brake shoe through a pivot structure of the brake shoe to provide improved braking performance.

Further, the drum brake according to the embodiment of the present disclosure can simplify a structure thereof through the pivot structure of the brake shoe, and accordingly, the number of components can be reduced.

Although one embodiment of the present disclosure is described above, the spirit of the present disclosure is not limited by the embodiment shown in the description, and although those skilled in the art may provide other embodiments through the addition, change, or removal of the components within the scope of the same spirit of the present disclosure, such embodiments are also included in the scope of the spirit of the present disclosure.

What is claimed is:

1. A drum brake including a drum configured to rotate together with wheels, and a first brake shoe and a second brake shoe to which linings that rub against an inner circumferential surface of the drum are attached, the drum brake comprising:
a first pivot fixing part configured to fix one end of the first brake shoe in a pivoting manner so that the first brake shoe operates outwardly and thus the lining of the first brake shoe rubs against the inner circumferential surface of the drum when the first brake shoe pivots in one direction with respect to the one end of the first brake shoe; and
a second pivot fixing part configured to fix one end of the second brake shoe in a pivoting manner so that the second brake shoe operates outwardly and thus the lining of the second brake shoe rubs against the inner circumferential surface of the drum when the second brake shoe pivots in the other direction with respect to the one end of the second brake shoe.

2. The drum brake of claim 1, wherein the first pivot fixing part and the second pivot fixing part each includes a fixing pin fixed to an anchor block through the one end of the first brake shoe and the one end of the second brake shoe, respectively.

3. The drum brake of claim 2, wherein:
each of the first brake shoe and the second brake shoe includes a rim having an outer circumferential surface to which the lining is attached, and a plate-shaped web coupled to an inner circumference of the rim; and
the first pivot fixing part and the second pivot fixing part are fixed to the anchor block through the web of the first brake shoe and the web of the second brake shoe, respectively.

4. The drum brake of claim 1, wherein:
the one end of the first brake shoe and the one end of the second brake shoe are disposed adjacent to each other; and
the first pivot fixing part and the second pivot fixing part are symmetrically disposed.

5. The drum brake of claim 4, wherein the other end of the first brake shoe and the other end of the second brake shoe are disposed to come into contact with a wheel cylinder configured to receive a braking hydraulic pressure to operate the first brake shoe and the second brake shoe outwardly.
